(19) United States
(12) Patent Application Publication
(10) Pub. No.: US 2026/0050631 A1
(43) Pub. Date: Feb. 19, 2026

(54) UPDATING GRAPH DATABASES BY USING COMPUTATION GRAPHS A Method of updating graph databases by using computation graphs

(71) Applicant: Verses AI, Inc., New Westminster (CA)

(72) Inventors: Alec Daniel Dunsmoir Tschantz, West End (AU); Alexander Bernard Kiefer, Arverne, NY (US); Prasaanth Sridharan, Waterloo (CA); Sara K. Brazille, Montreal (CA)

(21) Appl. No.: 18/809,219

(22) Filed: Aug. 19, 2024

(51) Int. Cl. G06F 16/23; G06F 16/2455; G06F 16/901

(52) U.S. Cl. CPC G06F 16/9024; G06F 16/2358; G06F 16/24565

(57) ABSTRACT

In a computation graph database, the updating of values includes identifying an entity that is changed and executing data link programs of links connecting the entity that changed with other entities, and updating the values of the entities that are connected to the changed entity.

### FIELD OF THE INVENTION

This application relates to techniques for updating structured databases.

### BACKGROUND OF THE INVENTION

Databases are structured data stores that can be queried to retrieve the information they contain. Databases can be structured in different ways, thereby allowing for storing and querying simpler or richer information about simple or complex systems. Simpler databases such as relational databases structure data using rows and columns to allow searching and comparing entities based on their properties (e.g., storing “items >$5”). Graph databases structure data using relationships, or edges, that connect nodes and that can give cause-consequence, or parent-children information (e.g., storing “box contains item”). Vector databases structure vectorised representations of entities which allows for querying based on mathematical operations such as cosine similarity (e.g., storing “item resembles sunglasses”). Finally, vector graph document databases are complex databases whose structure combines relational, graph, and vector database information structures (e.g., store “products >$5 contained in a box and that resemble sunglasses”).

One challenge with database management is populating and updating the database with accurate, useful and up-to-date information. The difficulty in populating and updating the database depends on the type of information being added as well as on the complexity of the database. For instance, simpler databases such as relational databases will contain easy to manage information (e.g., updating the cell of the age column for each person according to their birthdate). In turn more sophisticated databases such as vector graph document databases require update methods that involve more complex operations (e.g., using a logical or mathematical operation to update the values for an entity related to the change in value of another entity).

A difficulty with maintaining complex databases such as vector graph document databases is that the information needed to maintain the database might not always be directly available, or the change in the value of an entity might entail a change in the value of another entity for which we cannot have up to date information (e.g., if the frequency at which the entity is monitored is low). Thus, unless each entity within a complex system that a database is intended to represent is monitored in real time, and unless the database updated accordingly, the database's representation of that system will be inaccurate. For instance, observed glass debris on a warehouse floor might change the value of an unobserved current value of an “inventory” entity (e.g., glass bottles). The problem of maintaining a complex database based on sparse information content becomes increasingly difficult to solve as the system recorded by the database becomes more complex and open to contingencies.

### SUMMARY OF THE INVENTION

The claimed method allows for updating the information in a distant entity of a graph database, which for purposes of this invention includes a database with linked entities, including databases that have attributes comprising a link to perform operations over the linked entities whenever a change in the value of a connected entity is observed, e.g., vector graph document databases. In one embodiment, the claimed method applies to the updating of a vector graph document database using a hyperspatial modeling language (HSML)—see definitions, and implemented as a computation graph-see definition, though is not limited to the use of HSML but could be implemented using other modeling languages that have the properties of HSML, wherein the links between the entities in the vector graph document database can perform transform operations that allow a change in one node to update the information in another node for which we have not observed new data.

### Definitions Databases are queryable data stores. The three common classes of databases are the relational databases, the graph databases, and the vector databases.

Relational databases store data in a way that allows querying by comparing properties of the various stored entities (e.g., “give me the people whose age is greater than 25”).

Graph databases store data in a way that allows for querying by looking at the relation between the stored entities (e.g., “give me the children entities to the Steve entity). They represent entities in the world and the relationships between them. Entities are any physical or conceptual “thing” that has meaning in the real world (e.g., a robot, a sofa, a waypoint in space that refers to a location where one can go, a specification of an activity, etc.). Relationships between entities are expressed as edges that connect nodes and that can give cause-consequence, or parent-children information.

Vector databases store vectorised representations of the entities so as to allow for querying based on mathematical operations such as cosine similarity (e.g., “give me the nearest object to the sunglasses entity).

Vector graph document databases are databases whose structure allows for mix queries combining relational, graph, and vector databases type queries (e.g., “give me the products whose prices are greater than 5 dollars and that are sold by the company X, and whose description best matches that of sunglasses”).

Hyperspace Modeling Language (HSML) is a structured modeling language that can be used to encode information. HSML encodes information in both graph data formats and vector data formats. The two basic types of entities in HSML are the main entities and the link entities. The main entities correspond to nodes in a graph (e.g., the node representing a “box”, or a “location”), and the link entities correspond to the edges in a graph (e.g., the relation “is at” between the “box” and the “location”). The main entity document includes a field for a Unique IDentifier (UID) tag field called Spatial Web Unique IDentifier (SWID), a name field (optional), a description field (optional), and a schema field, or array of schema fields (denoted as @schema). The entities (main and link) about which the database contains information are represented as objects in HSML that are defined as JSON documents. All entities including the link entities and main entities have a SWID and have a reference to a schema document that defines the properties for the entity. Link entities define the relation between one or more source and destination main entities. A link defines the relationship between two entities (e.g., “Ray-Ban sunglasses” “are sold by” “the company X”) and contain a source-entity-UID field and a destination-entity-UID field. HSML allows for two types of links: normal links and data links. Normal links provide parent-child relationships information between entities. Data links are links that allow for performing operations on entities and contain a transform field, which links to a program that can perform an operation between entities (e.g., decrement the amount of sunglasses by 1 when selling a pair). Data links include two fields, which are the program field—indicating the program to be executed—and the data field—indicating the type of data over which the program should execute.

The present invention is, however, not limited to the use of HSML but could be implemented using other modeling languages that allow one or more entities to be related with a link that performs the functions of a data link. Thus, the datalinks, which allow for the computation to be performed over the linked entities, is the only feature of HSML that is necessary in any other modeling language or markup language for the implementation of the claimed method. Other structured modeling language and markup languages can therefore be used to implement the claimed method-the only requirement is that those modeling languages or markup languages support functions like those of datalinks.

A computation graph is a directed graph with nodes representing variables and edges representing transformations in the value of a node that can occur when an update happens to a connected node.

According to the invention there is provided a method of updating a graph database implemented as a computation graph, wherein the computation graph includes a source node, one or more destination nodes, and links connecting the source node with the destination nodes, wherein one or more links define the logic of the relationships between the nodes, the method comprising: analyzing the logic in each of the links; implementing the logic defined in the one or more links, and implementing an execute and update method wherein the logic defined in the one or more links is executed upon a change in the source node, or any other trigger of the logic, and wherein all the destination nodes linked with the source node are updated according to the logic defined in the one or more links. The logic can define a mathematical operation, logical operation or any other operation between the nodes. For purposes of this invention, the term trigger refers to the event upon which the logic of the link is executed.

In one embodiment of this invention, the code for the claimed method is implemented as a class in the Python programming language. In one implementation, the update process follows a three-stage procedure implemented through the following methods:
1. Identification method: Upon a state change of or in a main entity (e.g., data streamed from a sensor), the datalinks that are connected to the main entity are identified.
2. Execution method: Upon identification of datalinks that relate a main entity to other main entities, the program(s) of the datalink(s) linking the entity that underwent the state change and the entities connected to said entity that underwent the state change, are executed.
3. Update method: Upon execution of the datalink program(s), the values of the connected entities are updated according to the datalink program(s).

### BRIEF DESCRIPTION OF THE DRAWINGS

FIG. 1 depicts one embodiment of a HSML vector graph document database;

FIG. 2 illustrates an example of a computation graph performing an operation, and

FIG. 3 depicts an example of a HSML vector graph document database implementing a computation graph.

### DETAILED DESCRIPTION OF THE INVENTION

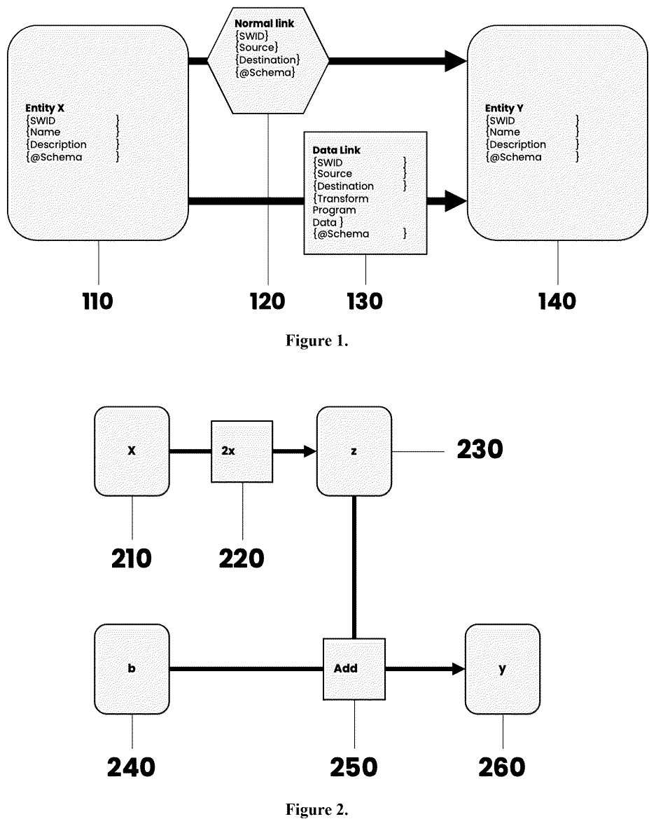

FIG. 1 depicts a HSML vector graph document database. 110 Presents a main entity X with a SWID tag field, a name field (optional), a description field (optional), and a schema, or array of schema fields (denoted as @schema). 120 presents a normal link with source and destination fields, and that indicates that entity Y is the child (i.e., destination) of entity X (i.e., source). 130 presents a data link with source, destination, transform, program and data fields. 140 presents the entity Y with a SWID tag field, a name field (optional), a description field (optional), and a schema, or array of schema fields.

FIG. 2 illustrates a computation graph performing the operation “y=2x+b” over the variables y and x. When change in an entity X 210 is observed, the value of the entity y 260 is updated. The update rule is operated through two transforms, which are transform 220, which calculates two times the value of x (2x) to define variable z 230, and transform 250, which adds variable z to variable b 240 to update variable y 260. This operation thus requires a third intermediary entity z 230 that is constructed for the purposes of evaluating the expression operated by the transform in 220.

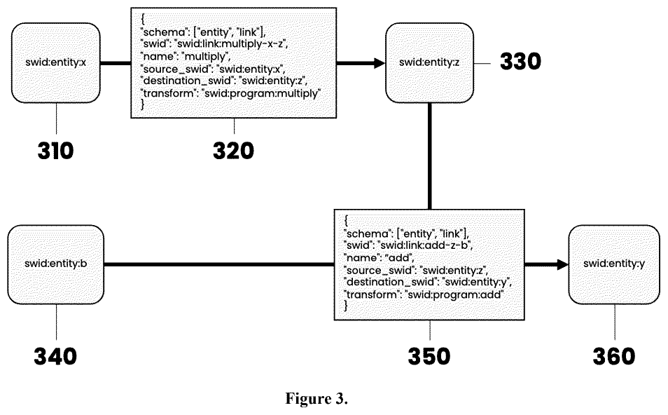

FIG. 3 depicts a HSML vector graph document database implementing a computation graph. A JSON document with a SWID for a main entity X 310 is defined as “swid:entity:x”. A JSON document with a SWID for a main entity Z 330 is defined as “swid:entity:z”. A JSON document with a SWID for a main entity Y 360 is defined as swid:entity:y. A JSON document with a SWID for a main entity b 340 is defined as swid:entity:b. A JSON document with a SWID for a datalink entity 320 with a transform field that references a program “swid:program:multiply” that multiplies the x entity by 2, and that assigns the result to the destination main entity z. This means that every time that the main entity x is observed, the entity z will be updated according to the problem (e.g., if x=2, then z will=4), following the identification method (i.e., finding the datalinks between x, z, b and y) and the execution method (i.e., executing the programs on the datalinks) and the update method (i.e., updating the y entity). A JSON document with a SWID for a datalink entity 350 with two sources z and b and one destination y with a transform field that references a program “swid:program:add” adds the value of the main entity b to the value of the main entity z and updates the entity y accordingly.

While the present invention has been described with respect to a particular example, it will be appreciated that it can be implemented for many different applications to update graph databases as defined in this application and using any modeling language or markup language with datalink functionality as discussed herein.

1. A system for controlling an agent by managing information in a graph database implementing the Hyper Space Modelling Language (HSML) using a computation graph, comprising
a processor on a computer system that can be used to interact with a computation graph database,
a computation graph database structured with a Hyperspatial Modeling Language (HSML) to define an HSML graph, wherein the HSML defines the syntax for translating entities described in natural language into vectorized representations of those entities, wherein the HSML graph defines a special implementation of a computation graph whose syntax defines entities in physical or virtual space that the agent interacts with, each entity comprising an entity type, and 4 entity subtypes that include (i) schema (ii) vector space, (iii) links, (iv) datalinks, wherein the schema contains a vectorization field for receiving a vector of the vectorized entity that is represented by the HSML graph, and wherein the vector space describes the structure of the vectors for the vectorized entity, and wherein the links define the relationships between two or more entities, to facilitate computation over the stored HSML entities, wherein the processor or computer system supports
create, read, update, and delete (CRUD) functionalities to create, read, update, and delete entities in the computation graph database.

2. A method performed by one or more computers for managing information in a graph database using a computation graph, wherein the computation graph includes one or more source nodes, one or more destination nodes, and links connecting the source nodes with the destination nodes, wherein one or more links capable of computation define the operations between the source and destination nodes, the method comprising,
providing a computation graph database,
structuring the computation graph of the computation graph database as an HSML computation graph using the Hyperspatial Modelling Language to make the computation graph database capable of computation over stored entities using links that are capable of computation,
receiving a user input,
implementing the operations defined in one or more of the links,
executing the operations defined in the links upon receipt of the user input to a destination node,
updating all the destination nodes according to the operations defined in the links upon receipt of the user input, or any other trigger of the computational operations by a change in a source node,
returning the value for set of entities related to the user input.

3. A method of claim 2 wherein the logic operations can define a mathematical operation, logical operation or any other operation between the nodes.

4. A method of claim 2, wherein the user input is received through create, read, update, and delete (CRUD) functionalities to communicate with the computation graph database.
